(19) United States
(12) Patent Application Publication
(10) Pub. No.: US 2007/0049221 A1
(43) Pub. Date: Mar. 1, 2007

(54) Multiple output RF signal generator

(75) Inventor: Donald William Metzger, Colorado Springs, CO (US)

Correspondence Address: LAW OFFICE OF DALE B. HALLING, LLC, 655 SOUTHPOINTE CT, SUITE 100, COLORADO SPRINGS, CO, 80906, US

(73) Assignee: Donald William Metzger

(21) Appl. No.: 11/504,124

(22) Filed: Aug. 15, 2006

Related U.S. Application Data
(60) Provisional application No. 60/712,232, filed on Aug. 29, 2005.

(51) Int. Cl. H04B 1/04; H01Q 11/12

(52) U.S. Cl. 455/127.1

(57) ABSTRACT

A multiple output RF signal generator has a frequency translator. A modulator modulates the frequency translator. A number of power control modules each has an input that receives an output from a frequency translator.

### RELATED APPLICATIONS

The present invention claims priority on provisional patent application Ser. No. 60/712,232, filed on Aug. 29, 2005, entitled “Multiple Output RF Signal Generator” and is hereby incorporated by reference.

### FIELD OF THE INVENTION

The present invention relates generally to the field of test equipment and more particularly to a multiple output radio frequency signal generator.

### BACKGROUND OF THE INVENTION

Radio Frequency (RF) signal generators are used to test RF devices. RF waveforms have three principle characteristics: the modulation, frequency and power. A waveform can be modulated or unmodulated. An unmodulated waveform is a single sinusoid. A modulated waveform varies the amplitude, frequency or phase of the waveform to encode information on the waveform. As used herein, modulation includes the case of unmodulated signals. A waveform also has a fundamental or carrier frequency. If the output is unmodulated, then the carrier frequency is the frequency of the sinusoid being produced. If the output is modulated, then the carrier frequency is that of the sinusoid which is being modulated. Finally, the power of the output signal can be controlled.

In previous RF signal generators, a single combination of these three characteristics is produced at any one time. As a result, multiple RF signal generators are needed if several RF signals, such as test signals, are needed. Thus there exists a need for a RF signal generator that can produce more than a single signal at any one time.

### SUMMARY OF INVENTION

The present invention overcomes these and other problems by having a number of power control modules coupled to the output of a modulator and frequency source. Each of the power control modules can be independently set to the desired power level. In a production testing environment it is often necessary to have multiple versions of the same RF signal at differing power levels. The present invention provides a low cost solution to the problem.

### BRIEF DESCRIPTION OF THE DRAWINGS

FIG. 1 is a block diagram of a multiple output RF signal generator in accordance with one embodiment of the invention.

### DETAILED DESCRIPTION OF THE DRAWINGS

The present invention describes a low cost, multiple output signal, RF signal generator. This invention significantly reduces the cost and complexity of production testing of RF circuits. The generator has a number of power control modules coupled to the output of the modulation and frequency source. Each of the power control signals are capable of providing a different power output.

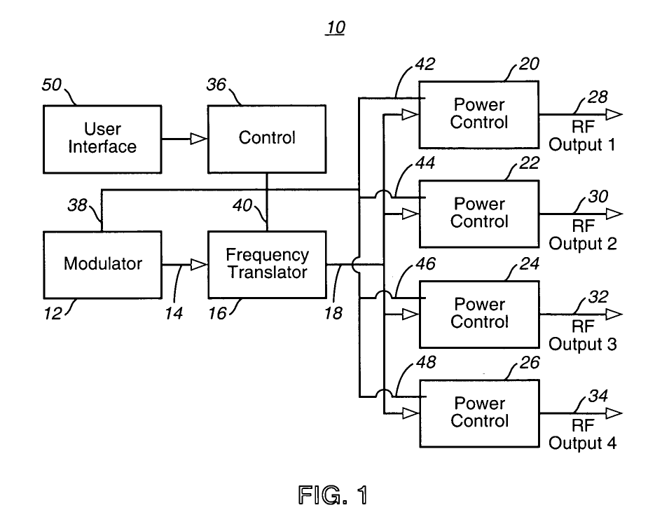

FIG. 1 is a block diagram of a multiple output RF signal generator 10 in accordance with one embodiment of the invention. The signal generator 10 has a modulator 12 with an output 14 connected to a frequency translator 16. The output 18 of the frequency translator is split into a plurality of signals. Each of the plurality of signals is coupled to an input of a plurality of power control modules 20, 22, 24, 26. Note that while four power control modules are shown, there could be any number of power control modules. Each of the power control modules 20, 22, 24, 26 has a separately controllable output level control. As a result, the generator 10 has multiple output signals 28, 30, 32, 34. A controller 36 has a modulation definition signal 38 that defines all the aspects of the modulation signal. For instance, the modulation signal might be AM (Amplitude Modulation), FM (Frequency Modulation), PM (Phase Modulation), ASK (Amplitude Shift Keying), FSK (Frequency Shift Keying), PSK (Phase Shift Keying) and variations thereon. The modulation might be a spread spectrum signal and the underlying data might be a pseudorandom or other information signal. All of these parameters are defined in the modulation definition signal 38. The controller 36 also defines the state of the frequency translator 16 with a frequency control-signal 40. The frequency control signal 40 defines the center frequency or carrier frequency of the output signal. Each of the power control modules 20, 22, 24, 26 receives a separate power control signal 42, 44, 46, 48 that defines the output power of each signal. A user interface 50 is used to define all the characteristics of the signal generator 10. In addition, the signal generator 10 may be controlled by a computer either directly or over a network. The network may be a LAN (Local Area Network), WAN (Wide Area Network) or the world wide web.

In operation, the user enters the modulation parameters and carrier frequency in the user interface 50. The controller 36 sends a message to the modulator 12 and frequency translator 16 to implement the command. The user also enters the output power for each of the power control modules 20, 22, 24, 26. The controller 36 sends power control messages to each of the power control modules 20, 22, 24, 26. At the outputs 28, 30, 32, 34 are four versions of the same RF signal with differing output powers. Note that not all outputs have to be on and the signal generator 10 can be made with more or fewer power control modules. Having multiple versions of the same signal in one signal generator significantly reduces the cost of testing in a production environment, since the user interface, controller, modulator and frequency translator would have to be duplicated for every signal in a conventional RF signal generator.

Thus there has been described a multiple output RF signal generator that is inexpensive and easy to use. This RF signal generator is particularly useful and cost effective in a production testing environment.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A multiple output RF signal generator comprising:
a frequency translator;
a modulator, modulating the frequency translator; and
a plurality of power control modules each having an input that receives an output from the frequency translator.

2. The signal generator of claim 1, wherein each of the plurality of power control modules has a separate output level control.

3. The signal generator of claim 2, further including a controller having a modulation definition signal connected to the modulator.

4. The signal generator of claim 2, further including a controller having a separate power control signal connected to each of the plurality of power control modules.

5. The signal generator of claim 4, wherein the controller has a frequency control signal connected to the frequency source.

6. The signal generator of claim 4, further including a user interface coupled to the controller.

7. A multiple output RF signal generator comprising:
a frequency source; and
a plurality of power control modules each having an input that receives an output from the frequency source.

8. The signal generator of claim 7, further including a modulator, modulating the frequency source.

9. The signal generator of claim 8, wherein each of the plurality of power control modules has a separate output level control.

10. The signal generator of claim 9, further including a controller having a separate power control signal connected to each of the plurality of power control modules.

11. The signal generator of claim 10, wherein the controller has a frequency control signal connected to the frequency source.

12. The signal generator of claim 11, wherein the controller has a modulation definition signal connected to the modulator.

13. The signal generator of claim 12, further including a user interface coupled to the controller.

14. A multiple output RF signal generator comprising:
a frequency translator;
a modulator, modulating the frequency translator; and
a plurality of power control modules each having an input that receives an output from the frequency translator, wherein each of the plurality of power control modules has a separate output level control.
